(19) United States
(12) Patent Application Publication
(10) Pub. No.: US 2010/0070694 A1
(43) Pub. Date: Mar. 18, 2010

(54) COMPUTER SYSTEM HAVING RAM SLOTS WITH DIFFERENT SPECIFICATIONS

(75) Inventor: CHUNG-TA CHIN, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTEK COMPUTER INC., Taipei (TW)

(21) Appl. No.: 12/555,123

(22) Filed: Sep. 8, 2009

(30) Foreign Application Priority Data
Sep. 12, 2008 (TW) 097135182

(51) Int. Cl. G06F 12/06; G06F 13/00

(52) U.S. Cl. 711/104; 710/301; 711/E12.084

(57) ABSTRACT

A computer system is able to adopt a RAM module belonged to a first specification with a RAM slot belonged to a second specification. The computer system comprises: a RAM module belonged to the first specification, a RAM sot belonged to the second specification, and a RAM controller connected to the RAM slot. The data, derived from the RAM module and only existed in the first specification, is transmitted to the RAM controller via the N/A pins of the RAM slot when the RAM module is plugged in the RAM slot.

### FIELD OF THE INVENTION

The present invention relates to a computer system having RAM slots belonged to different specifications, and more particularly to a computer system having a DDR3 RAM slot capable of adopted with a DDR2 RAM module or having a DDR2 RAM slot capable of adopted with a DDR3 RAM module.

### BACKGROUND OF THE INVENTION

FIG. 1 is a block diagram of a computer system. The computer system 10 includes a central processing unit (CPU) 102, a north bridge 104, and a south bridge 106. The north bridge 104 deals with the data transmitting between the high-speed devices, such as the CPU 102, the random-access-memory (RAM) 108, or the advanced graphics port (AGP) 110. The south bridge 106 deals with the data transmitting between the related low-speed devices, such as the integrated device electronics (IDE) device 112 or the universal serial bus (USB) device 114.

RAM 108 is the main device for the CPU 102 to directly store or retrieve data. That is, the instructions, commands, or data needed by the CPU 102 are temporarily stored at RAM 108. Today, RAM 108 is already modulized.

FIG. 2 is a scheme illustrating a RAM module. The RAM module 20 includes a set of RAM DIP 202, a circuit board 204, and a pin set 206, where the set of RAM DIP 202 is soldered on the circuit board 204. The capacity of the RAM module 20 is the sum of the capacity of the set of RAM DIP 202. For example, if there are eight 128 MB RAM DIPs 202 on the RAM module 20, the capacity of the RAM module 20 is 128 Mb×8=1 GB.

Via the plugging in a RAM slot on a motherboard, the RAM module is connected to the motherboard of the computer system. Generally, there are two or four RAM slots on a motherboard. If there are two RAM slots on the motherboard and each RAM slot is plugged in a 256 MB RAM module, the RAM capacity of the computer system is 256 MB×2=512 MB. Similarly, if there are four RAM slots on the motherboard and each RAM slot is plugged in a 256 MB RAM module, the RAM capacity of the computer system is 256 MB×4=1 GB.

Basically, the specification of RAM can be categorized to single data rate (SDR) and double data rate (DDR). SDR means data is processed (read or write) once in a RAM clock. That is, data can only be read/or write either at the rising/or the falling edge at one RAM clock. DDR means data is processed (read or write) twice in a RAM clock. That is, data can be read/or write both at the rising and falling edges at one RAM clock. In other words, the DDR RAM has a bandwidth twice than the bandwidth of the SDR RAM.

The specification of DDR can be further categorized to three types: first generation of DDR (DDR1), second generation of DDR (DDR2), and third generation of DDR (DDR3), where the DDR3 the latest specification of DDR. The working frequency of the DDR3 RAM is higher than that of the DDR2 RAM, however, the working voltage needed by the DDR3 RAM (1.5V) is less than that of the DDR2 RAM (1.8V). In other words, DDR3 RAM has a higher speed but consumes less power than DDR2 RAM.

If DDR2 RAM slots are implemented on a motherboard, the motherboard is defined as a DDR2 motherboard. Similarly, if DDR3 RAM slots are implemented on a motherboard, the motherboard is defined as a DDR3 motherboard. DDR3 is not compatible to DDR2. That is, if a RAM module on a motherboard is upgraded from DDR2 to DDR3, the motherboard and the RAM slot are accordingly needed to be upgraded to DDR3. In other words, user cannot plug in a DDR3 RAM module to a DDR2 RAM slot on a DDR2 motherboard, or, user cannot plug in a DDR2 RAM module to a DDR3 RAM slot on a DDR3 motherboard.

However, the modern RAM controller in the north bridge supports both the DDR2 and DDR3. In other words, if the motherboard is a DDR-Combo motherboard which means both the DDR2 and DDR3 RAM modules are arranged on the motherboard, user can freely choose the DDR2 RAM module/or DDR3 RAM module to plug in the corresponding RAM slot. FIG. 3 is a block diagram of a DDR-Combo motherboard supporting both the DDR2/DDR3 RAM modules. The DDR-Combo motherboard 30 includes a north bridge 302, a first DDR2 RAM slot 304-1, a second DDR2 RAM slot 304-2, a first DDR3 RAM slot 306-1, and a second DDR3 RAM slot 306-2. The north bridge 203 further includes a RAM controller 308. As depicted in FIG. 3, the DDR-Combo motherboard 30 supports two DDR2 RAM slots and two DDR3 RAM slots. That is, user can plug in one or two DDR2 RAM modules to the DDR2 RAM slots if user prefers the DDR2 RAM module, or, user can plug in one or two DDR3 RAM modules to the DDR3 RAM slots if user prefers the DDR3 RAM module.

However, the DDR-Combo motherboard 30 does not allow DDR2 RAM module and DDR3 RAM module simultaneously plugged in the corresponding RAM slots. In other words, once the user plugs the DDR2 RAM modules in the DDR2 RAM slots, the DDR3 RAM modules are not allowed to be plugged in the DDR3 RAM slots, so as the resource of the DDR3 RAM slots on the DDR-Combo motherboard 30 is waste. Similarly, once the user plugs the DDR3 RAM modules in the DDR3 RAM slots, the DDR2 RAM modules are not allowed to be plugged in the DDR2 RAM slots, so as the resource of the DDR2 RAM slots on the DDR-Combo motherboard 30 is waste.

### SUMMARY OF THE INVENTION

Therefore, one object of the present invention is to design a computer system that the DDR2 RAM module can be adopted with the DDR3 RAM slot, or, the DDR3 RAM module can be adopted with the DDR2 RAM slot, on a same motherboard.

The present invention provides a computer system having memory slots with different specifications capable of being plugged in a first memory module belonged to a first specification and a second memory module belong to the first specification, comprising: a first memory slot, belonged to the first specification, including a first group of common pins, a first group of exclusive pins, and a first group of N/A pins; a second memory slot, belonged to a second specification, including a second group of common pins, a second group of exclusive pins, and a second group of N/A pins; and a memory controller, connected to the first memory slot and the second memory slot, including a third group of common pins, a third group of exclusive pins, and a fourth group of exclusive pins; wherein, when the second memory module is plugged in the second memory slot, a first group of common data derived from the second memory module is transmitted to the third group of common pins of the memory controller via the second group of common pins of the second memory slot, and a first group of exclusive data derived from the second memory module is transmitted to the third group of exclusive pins of the memory controller via the second group of N/A pins of the second memory slot.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a block diagram of a computer system;

FIG. 2 is a scheme illustrating a RAM module;

FIG. 3 is a block diagram of a DDR-Combo motherboard supporting both the DDR2/DDR3 RAM modules;

FIG. 4A is scheme illustrated the pins arranged in DDR2;

FIG. 4B is scheme illustrated the pins arranged in DDR3;

FIG. 5A is another scheme illustrated the pins arranged in DDR2;

FIG. 5B is another scheme illustrated the pins arranged in DDR3;

FIG. 6A a diagram of the data transmitting between a north bridge and a DDR2 RAM;

FIG. 6B a diagram of the data transmitting between a north bridge and a DDR3 RAM; and

FIG. 7 is a scheme exemplifying the data transmitting between a north bridge, DDR2 and DDR3 RAM modules, and DDR2 and DDR3 RAM slots in the present invention.

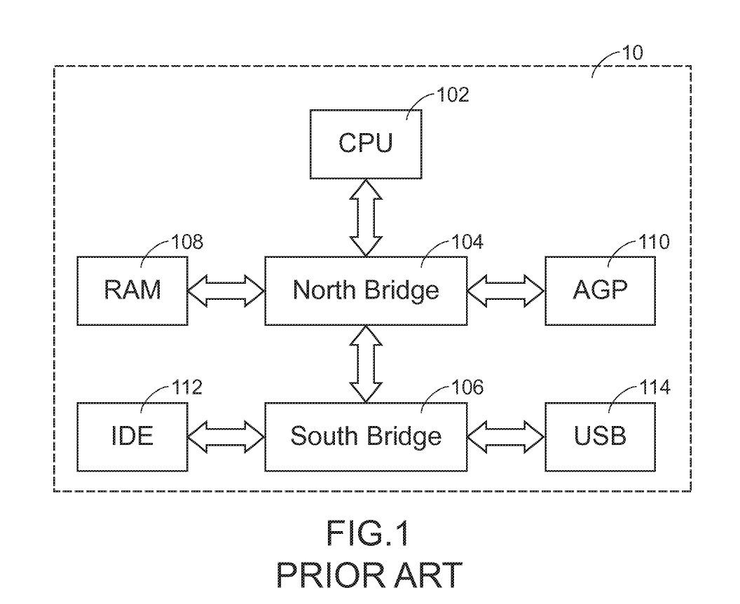

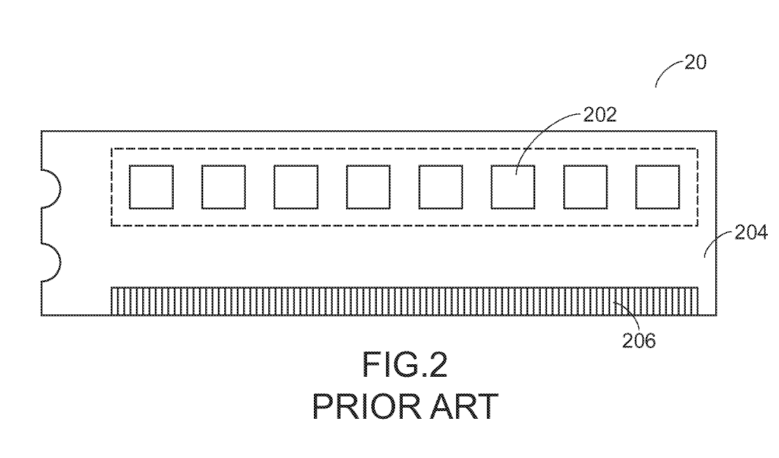

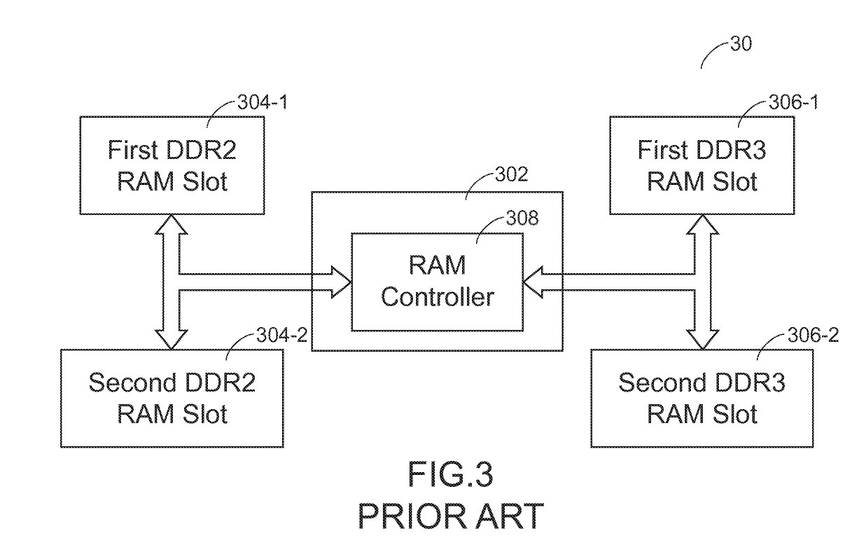

### DETAILED DESCRIPTION OF PREFERRED EMBODIMENTS

The present invention is a computer system with a DDR-Combo motherboard capable of simultaneously supporting both the DDR2 RAM module and the DDR3 RAM module. That is, DDR2 RAM module can be adopted with the DDR3 RAM slot on the motherboard of the present invention, or, DDR3 RAM module can be adopted with the DDR2 RAM slot on the motherboard of the present invention.

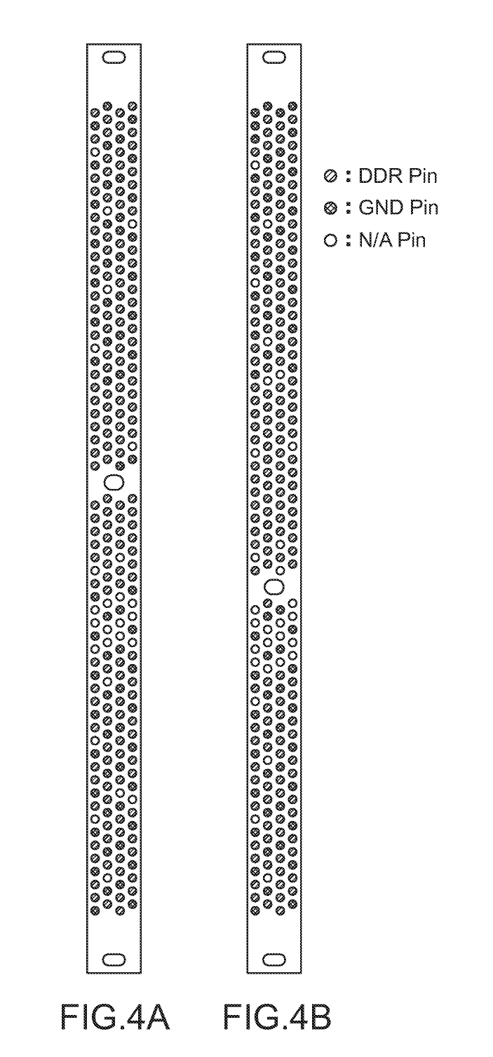

As described above, DDR3 is not compatible to DDR2. However, most of the pins (about 90%) in DDR3 specification are same as the pins in DDR2 specification. FIG. 4A and FIG. 4B are schemes illustrated the pins arranged in DDR2 and DDR3, respectively. As depicted in FIG. 4A and FIG. 4B, both DDR2 and DDR3 include 240 pins, those are DDR pins, ground (GND) pins, and N/A (or dummy) pins, where the DDR pin is for transmitting data, the GND pin is connected to ground, the N/A pin is reserved for expanding functions.

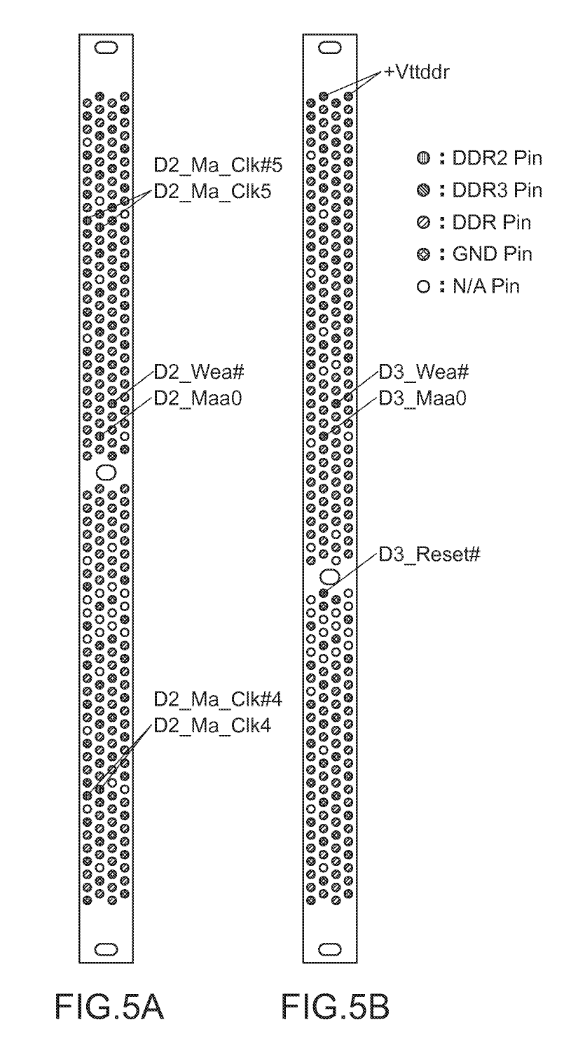

For the convenience to indicate the common/or different pins between the DDR2 and DDR3 specifications, FIG. 5A and FIG. 5B are another modified schemes illustrated the pins arranged in DDR2 and DDR3, respectively. As depicted in FIG. 5A, the 240 pins in DDR2 can be categorized to three groups. The first group: the pins only belonged to DDR2 specification, such as D2_Ma_Clk#5, D2_Ma_Clk5, D2_Wea#, D2_Maa0, D2_Ma_Clk#4, D2_Ma_Clk4, where these pins can be named as DDR2 pins. The second group: GND pins and the pins both belonged to DDR2 and DDR3 specifications, where the pins both belonged to DDR2 and DDR3 specifications can be named as DDR pins. The third group: the N/A pins. As depicted in FIG. 5B, the 240 pins in DDR3 can be also categorized to three groups. The first group: the pins only belonged to DDR3 specification, such as +Vttddr, D3_Wea#, D3_Maa0, D3_Reset#, where these pins can be named as DDR3 pins. The second group: GND pins and DDR pins. The third group: N/A pins. As depicted in FIG. 5A and FIG. 5B, most of the pins in DDR2 and DDR3 specifications belong to the second group, that is, most of pins in DDR2 and DR3 specifications are in common.

According to the above description, data derived from DDR2 RAM can be categorized to three groups. The first group: DDR2/DDR3 data which stands for the data derived from GND pins and DDR pins, in other words, DDR2/DDR3 data is compatible to both the DDR2 and DDR3 specifications. The second group: DDR2 data which stands for the data derived from the DDR2 pins, in other words, DDR2 data is only compatible to the DDR2 specification but not compatible to the DDR3 specification. The third group: N/A data that stands for the data derived from the N/A pins.

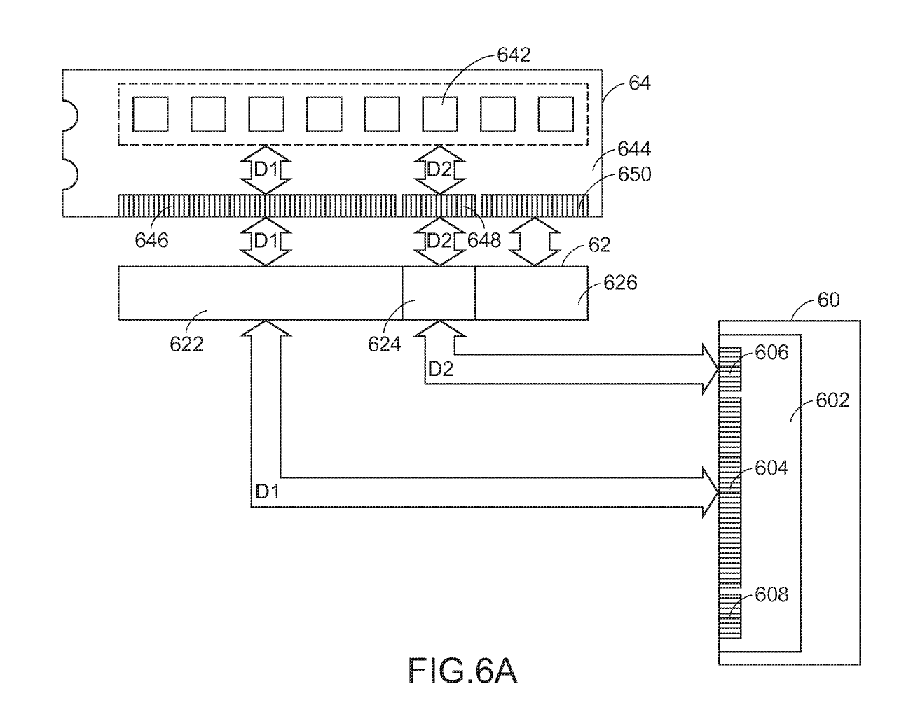

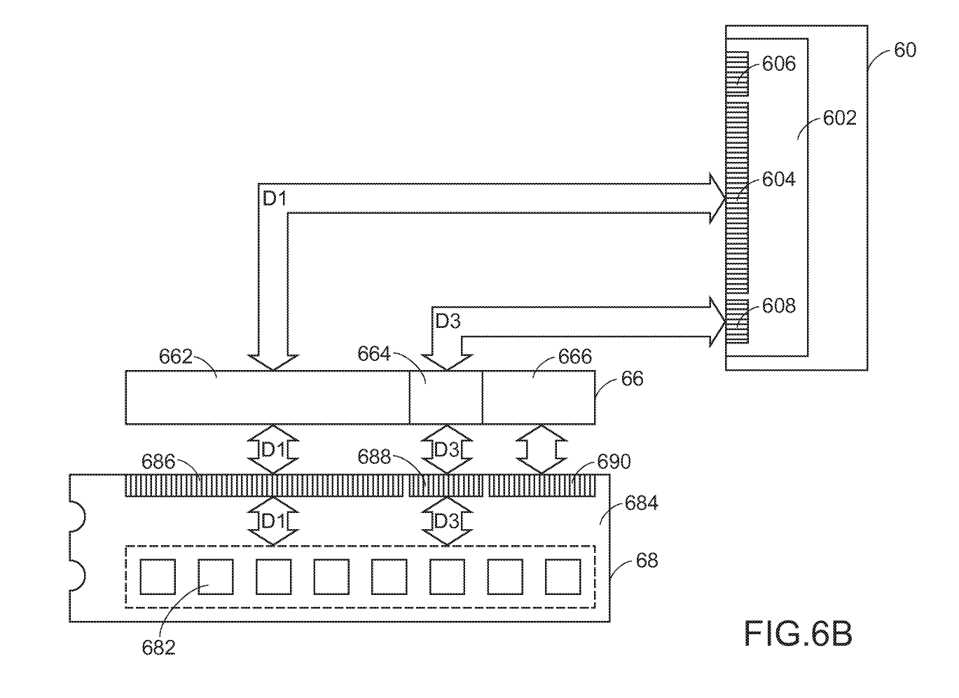

According to the categories of the data derived from the DDR2 RAM, a diagram of the data transmitting between a north bridge and a DDR2 RAM is shown in FIG. 6A. The system depicted in FIG. 6A includes a north bridge 60, a DDR2 RAM slot 62, and a DDR2 RAM module 64. The north bridge 60 further includes a RAM controller 602. The RAM controller 602 further includes a pin set 604 for transmitting the DDR2/DDR3 data (D1), a pin set 606 for transmitting the DDR2 data (D2), and a pin set 608 for transmitting the DDR3 data. The DDR2 RAM slot 62 further includes a pin set 622 for transmitting the DDR2/DDR3 data (D1), a pin set 624 for transmitting the DDR2 data (D2), and a pin set 626 for transmitting the N/A data. The DDR2 RAM module 64 further includes a set of DDR2 RAM DIP 642, a DDR2 circuit board 644, a pin set 646 for transmitting the DDR2/DDR3 data (D1), a pin set 648 for transmitting the DDR2 data (D2), and a pin set 650 for transmitting the N/A data.

As depicted in FIG. 6A, the DDR2/DDR3 data (D1) derived from the set of DDR2 RAM DIP 642 is first transmitted to the pin set 646 via the layout of the DDR2 circuit board 644. Then, the DDR2/DDR3 data (D1) is further transmitted to the pin set 622 of the DDR2 RAM slot 62. Then, the DDR2/DDR3 data (D1) is further transmitted to the pin set 604 of the RAM controller 602 via the layout of the motherboard (not shown). Similarly, the DDR2 data (D2) derived from the set of DDR2 RAM DIP 642 is first transmitted to the pin set 648 via the layout of the DDR2 circuit board 644. Then, the DDR2 data (D2) is further transmitted to the pin set 624 of the DDR2 RAM slot 62. Then, the DDR2 data (D2) is further transmitted to the pin set 606 of the RAM controller 602 via the layout of the motherboard. Therefore, all the data derived from the set of DDR2 RAM DIP 642 is successfully transmitted to the RAM controller 602. Furthermore, the pin set 650 of the DDR2 RAM module 64 is connected to the pin set 626 of the DDR2 RAM slot 62.

Similarly, data derived from DDR3 RAM can be categorized to three groups. The first group: DDR2/DDR3 data. The second group: DDR3 data which stands for the data derived from the DDR3 pins, in other words, DDR3 data is only compatible to DDR3 specification but not compatible to the DDR2 specification. The third group: N/A data.

Similarly, according to the categories of the data derived from the DDR3 RAM, a diagram of the data transmitting between a north bridge and a DDR3 RAM is shown in FIG. 6B. The system depicted in FIG. 6B includes a north bridge 60, a DDR3 RAM slot 66, and a DDR3 RAM module 68. The DDR3 RAM slot 66 further includes a pin set 662 for transmitting the DDR2/DDR3 data (D1), a pin set 664 for transmitting the DDR3 data (D3), and a pin set 666 for transmitting the N/A data. The DDR3 RAM module 68 further includes a set of DDR3 RAM DIP 682, a DDR3 circuit board 684, a pin set 686 for transmitting the DDR2/DDR3 data (D1), a pin set 688 for transmitting the DDR3 data (D3), and a pin set 690 for transmitting the N/A data.

As depicted in FIG. 6B, the DDR2/DDR3 data (D1) derived from the set of DDR3 RAM DIP 682 is first transmitted to the pin set 686 via the layout of the DDR3 circuit board 684. Then, the DDR2/DDR3 data (D1) is further transmitted to the pin set 662 of the DDR3 RAM slot 66. Then, the DDR2/DDR3 data (D1) is further transmitted to the pin set 604 of the RAM controller 602 via the layout of the motherboard (not shown). Similarly, the DDR3 data (D3) derived from the set of DDR3 RAM DIP 682 is first transmitted to the pin set 688 via the layout of the DDR3 circuit board 684. Then, the DDR3 data (D3) is further transmitted to the pin set 664 of the DDR3 RAM slot 66. Then, the DDR3 data (D3) is further transmitted to the pin set 608 of the RAM controller 602 via the layout of the motherboard. Therefore, all the data derived from the set of DDR3 RAM DIP 682 is successfully transmitted to the RAM controller 602. Furthermore, the pin set 690 of the DDR3 RAM module 68 is connected to the pin set 666 of the DDR3 RAM slot 66.

As described above in FIG. 5A and FIG. 5B, most of the data in both DDR2 and DDR3 specifications is in common (DDR2/DDR3 data). The only difference between the data in DDR2 and DDR3 specifications is DDR2 data and DDR3 data. Besides, both the number of the DDR2 data and the number of DDR3 data is less than the number of the N/A data. Therefore, via the re-layout of the circuit board attached with the DDR3 RAM module, the DDR3 data derived from the DDR3 RAM DIP can be first transmitted to the N/A pins of the DDR3 RAM module, then transmitted to the N/A pins of the DDR2 RAM slot, and finally transmitted to the pin set of the RAM controller for delivering the DDR3 data via the re-layout of the motherboard. Accordingly, the DDR3 RAM module adopted with the DDR2 RAM slot on a same motherboard of the present invention is achieved. Similarly, via the re-layout of the circuit board attached with the DDR2 RAM module, the DDR2 data derived from the DDR2 RAM DIP can be first transmitted to the N/A pins of the DDR2 RAM module, then transmitted to the N/A pins of the DDR3 RAM slot, and finally transmitted to the pin set of the RAM controller for delivering the DDR2 data via the re-layout of the motherboard. Accordingly, the DDR2 RAM module adopted with the DDR3 RAM slot on a same motherboard of the present invention is achieved.

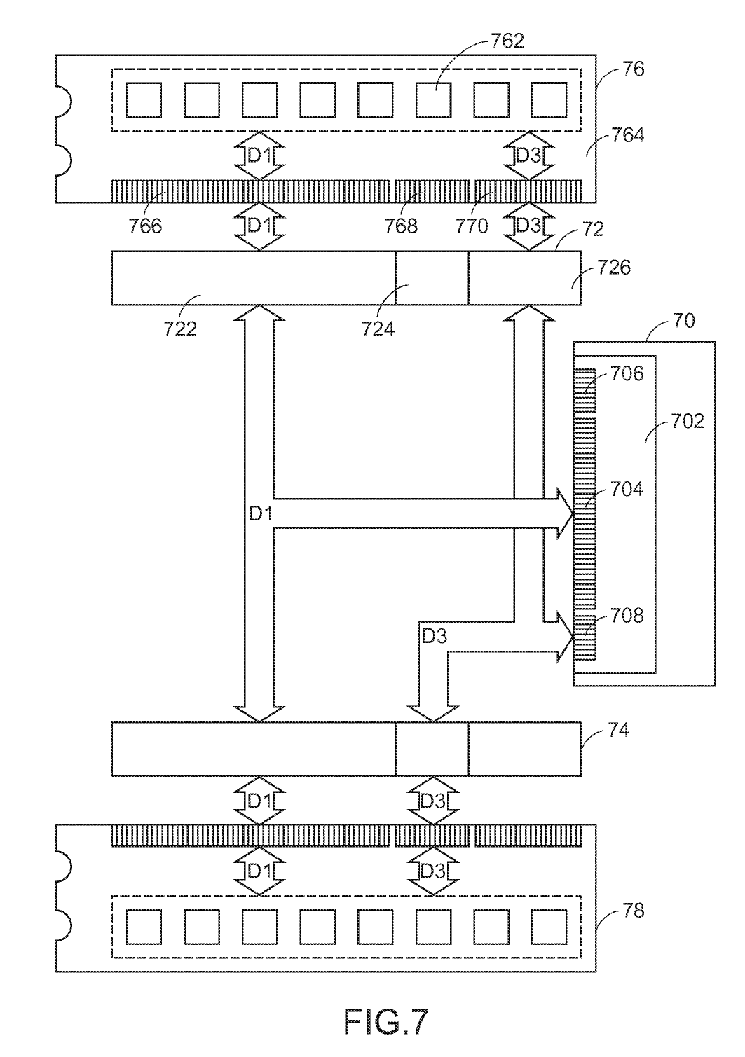

For the convenience to explain the present invention, only the DDR3 RAM module adopted with the DDR2 RAM slot on a same motherboard is took as an example. FIG. 7 is a scheme exemplifying the data transmitting between a north bridge, DDR2 and DDR3 RAM modules, and DDR2 and DDR3 RAM slots. The scheme depicted in FIG. 7 includes a north bridge 70, a DDR2 RAM slot 72, a DDR3 RAM slot 74, a first DDR3 RAM module 76, and a second DDR3 RAM module 78. The north bridge 70 further includes a RAM controller 702. The RAM controller 702 further includes a pin set 704 for transmitting the DDR2/DDR3 data (D1), a pin set 706 for transmitting the DDR2 data (D2), and a pin set 708 for transmitting the DDR3 data (D3). The DDR2 RAM slot 72 further includes a pin set 722 for transmitting the DDR2/DDR3 data (D1), a pin set 724 for transmitting the DDR2 data (D2), and a pin set 726 for transmitting the N/A data. The first DDR3 RAM module 76 further includes a set of DDR3 RAM DIP 762, a DDR3 circuit board 764, a pin set 766 for transmitting the DDR2/DDR3 data (D1), a pin set 768 originally designed for transmitting the DDR3 data (D3), and a pin set 770 originally designed for transmitting the N/A data.

Because the process of transmitting data, firstly derived from the second DDR3 RAM module 78, via the DDR3 RAM slot 74, and finally transmitted to the RAM controller 702, is already explained above in FIG. 6B, no unnecessary description is given here. Following is the description of the process of transmitting data, firstly derived from the first DDR3 RAM module 76, via the DDR2 RAM slot 72, and finally transmitted to the RAM controller 702.

First, the DDR2/DDR3 data (D1) derived from a set of DDR3 DIP 762 is first transmitted to the pin set 766 via the layout of the DDR3 circuit board 764. Then, the DDR2/DDR3 data (D1) is further transmitted to the pin set 722 of the DDR2 RAM slot 72. Then, the DDR2/DDR3 data (D1) is further transmitted to the pin set 704 of the RAM controller 702 via the layout of the motherboard (not shown). Furthermore, the DDR3 data (D3) derived from a set of DDR3 DIP 762 is first transmitted to the pin set 770 via the re-layout of the DDR3 circuit board 764. Then, the DDR3 data (D3) is further transmitted to the pin set 726 of the DDR2 RAM slot 72. Finally, the DDR3 data (D3) is further transmitted to the pin set 708 of the RAM controller 702 via the re-layout of the motherboard. Therefore, all the data derived from the DDR3 RAM DIP 762, including DDR2/DDR3 data (D1) and DDR3 data (D3), is successfully transmitted to the RAM controller 702, so as the motherboard system capable of adopting the DDR3 RAM module 76 to the DDR2 RAM slot 72 is implemented.

Because the number of the N/A data is greater than the number of the DDR2 data and DDR3 data, the DDR3 data (D3) derived from the DDR3 RAM DIP 762 is guaranteed to be successfully transmitted to the pin set 708 of the RAM controller 702 sequentially via the pin set 770 of the first DDR3 RAM module 76 and the pin set 726 of the DDR2 RAM slot 72.

Moreover, because the working voltage of the DDR3 RAM module 76 is 1.5V but the voltage supported to the DDR2 RAM slot 72 is 1.8V, a voltage-switch circuit (not shown in FIG. 7) is necessarily arranged on the motherboard of the present invention. Because no data is transmitted at the pin set 726 of the DDR2 RAM slot 72 if no RAM module is plugged in or the plugged in RAM module is DDR2, a plugging of the DDR3 RAM module 76 to the DDR2 RAM slot 72 can be detected by the motherboard if the voltage level at the pin set 726 is varied, accordingly, the working voltage supplied to the DDR2 RAM slot 72 is then switched from 1.8V to 1.5V by the power-switch circuit. Because the power-switch circuit is a well-known technique, no unnecessary description is given here.

Moreover, the characteristic of the present invention is still obvious if the RAM controller 702 is arranged from the north bridge 70 to the CPU (not shown in FIG. 7) by some chipset manufactories.

Moreover, although only DDR3 RAM module adopted with DDR2 RAM slot is took as an example in the present invention, the DDR2 RAM module adopted with DDR3 RAM slot can be achieved according to the same characteristic of the present invention.

Moreover, although only data transmitted from RAM module to RAM controller is took as an example in the present invention, data transmitted from RAM controller to RAM module can be achieved according to the same characteristic of the present invention.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A computer system having memory slots with different specifications capable of being plugged in a first memory module belonged to a first specification and a second memory module belong to the first specification, comprising:
a first memory slot, belonged to the first specification, including a first group of common pins, a first group of exclusive pins, and a first group of N/A pins;
a second memory slot, belonged to a second specification, including a second group of common pins, a second group of exclusive pins, and a second group of N/A pins; and
a memory controller, connected to the first memory slot and the second memory slot, including a third group of common pins, a third group of exclusive pins, and a fourth group of exclusive pins;
wherein, when the second memory module is plugged in the second memory slot, a first group of common data derived from the second memory module is transmitted to the third group of common pins of the memory controller via the second group of common pins of the second memory slot, and a first group of exclusive data derived from the second memory module is transmitted to the third group of exclusive pins of the memory controller via the second group of N/A pins of the second memory slot.

2. The computer system having memory slots with different specifications according to claim 1, wherein when the first memory module is plugged in the first memory slot, the first group of common data derived from the first memory module is transmitted to the third group of common pins of the memory controller via the first group of common pins of the first memory slot, and the first group of exclusive data derived from the first memory module is transmitted to the third group of exclusive pins of the memory controller via the first group of exclusive pins of the first memory slot.

3. The computer system having memory slots with different specifications according to claim 1, wherein the number of the second group of N/A pins is greater than the number of the second group of exclusive pins in the second memory slot.

4. The computer system having memory slots with different specifications according to claim 1, wherein the first group of common data is compatible to both the first specification and the second specification.

5. The computer system having memory slots with different specifications according to claim 1, wherein the first group of exclusive data is compatible to the first specification.

6. The computer system having memory slots with different specifications according to claim 1, wherein the memory controller is arranged in a north bridge.

7. The computer system having memory slots with different specifications according to claim 1, wherein the memory controller is arranged in a central processing unit.

8. The computer system having memory slots with different specifications according to claim 1, further comprising a power-switch circuit connected to the second memory slot, the power-switch circuit supplies a first voltage to the second memory slot if the first group of exclusive data is not detected to be derived to the second group of N/A pins of the second memory slot; and the power-switch circuit supplies a second voltage to the second memory slot if the first group of exclusive data is detected to be derived to the second group of N/A pins of the second memory slot.

9. The computer system having memory slots with different specifications according to claim 1, wherein the first specification is the specification of the second generation of double data rate (DDR2); and the second specification is the specification of the third generation of double data rate (DDR3).

10. The computer system having memory slots with different specifications according to claim 1, wherein the first specification is the specification of the third generation of double data rate (DDR3); and, the second specification is the specification of the second generation of double data rate (DDR2).
